(19) United States
(12) Patent Application Publication
(10) Pub. No.: US 2005/0030308 A1
(43) Pub. Date: Feb. 10, 2005

(54) Three-dimensional display method and device therefor

(76) Inventor: Yasuhiro Takaki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/493,065

(22) PCT Filed: Oct. 30, 2002
(86) PCT No.: PCT/JP02/11268

(30) Foreign Application Priority Data
Nov. 2, 2001 (JP) 2001-337309

(51) Int. Cl. G06T 15/00

(52) U.S. Cl. 345/419

(57) ABSTRACT

A three-dimensional display method and a device therefor are provided in which a number of images can be displayed in the horizontal directions while image skips can be eliminated by providing overlaps of display angular ranges between adjacent images having horizontal display directions.

A number of images are displayed in horizontal and vertical directions so that the display directions do not agree with each other, and by expanding vertical display angular ranges of entire images with a vertical-direction diffusion plate (17), a vertical display angular range common to the entire images is generated. In this common vertical display angular range, the entire images have different horizontal display directions. Thereby, a number of images can be displayed because image generating sources can be arranged also in the vertical direction in addition to the horizontal directions.

### TECHNICAL FIELD

The present invention relates to a three-dimensional display method and a device therefor, and in particular relates to a three-dimensional display method and a device therefor in that a plurality of images different in display directions are generated in horizontal and vertical directions, so that a number of images different in horizontal display directions are generated by expanding a display angular range of each image only in the vertical direction with a vertical-direction (one direction) diffusion plate.

### BACKGROUND ART

Human physiological factors of stereoscopic vision include binocular parallax, accommodation, congestion, and movement parallax. By satisfying these entire factors, a natural three-dimensional display is enabled.

As is understood from that a human has a pair of eyes, among the physiological factors of stereoscopic vision, the most influencing factor on stereoscopic perseption is the binocular parallax in which stereoscopic information is obtained from differences in images in the horizontal directions viewed from the pair of eyes.

Therefore, as a stereoscopic display system, a binocular stereoscopic display system shown in FIG. 1 has been used from long ago. In FIG. 1, reference numerals 1001a and 10001b denote left and right eyes; numerals 1002a and 1002b mirrors for the left and right eyes; and numerals 1003a and 1003b two-dimensional image displays for the left and right eyes. Images of the two-dimensional image displays 1003a and 1003b are displayed corresponding to the left and right eyes 1001a and 10001b.

This stereoscopic display system has the following problems. In order that the left and right eyes 1001a and 1001b can see respective different images, a special pair of glasses need to be put on. Also, when the head is moved, the image of an object does not change, i.e., so-called movement parallax is eliminated. The human eyes are focused not on a presented position of a three-dimensional object but on the surfaces of the two-dimensional image displays 1003a and 1003b, so that this contradiction causes fatigue.

The stereoscopic display system capable of solving the problems of the two-dimensional image display system described above is a multi-eye stereoscopic display system. This is a system in that images are simultaneously displayed in directions corresponding to a number of images of an object viewed from a number of directions, and a special pair of glasses is not necessary to be put on. When the head is moved, the image of an object changes, so that the movement parallax is obtained. Simultaneous observation is enabled by multiple persons. Furthermore, if the number of viewing points is increased to be 50 to 100, when the head is moved, the image of an object is smoothly switched, achieving the smooth movement parallax. Moreover, since light beams are condensed on a presented position of a three-dimensional object, it is known that human eyes are focused on the presented position of the object so that the fatigue as in the two-dimensional image display system is eliminated.

In the multi-eye stereoscopic display system, a conformation is achieved in that an image changes only in the horizontal direction. This is based on the fact that since human eyes are aligned in the horizontal direction, image-changes in the horizontal direction are particularly important in human stereoscopic sense. When the image changes are limited to the horizontal direction, the number of images to be displayed is decreased, simplifying a device. Therefore, there is an advantage that the amount of data during transmission and recording of stereoscopic images can be decreased.

FIG. 2 is a schematic view of a conventional device realizing the multi-eye stereoscopic display system. In the drawing, reference numeral 1101 denotes an eye; numeral 1102 a lenticular sheet; numeral 1103 a cylindrical lens constituting the lenticular sheet; numeral 1104 a two-dimensional image display device; and numeral 1105 a parallax image.

FIG. 3 is a schematic view of a device realizing the multi-eye stereoscopic display system with a configuration different from that of FIG. 2. In the drawing, reference numeral 1201 denotes a diffuse reflection plate; numeral 1202 a lenticular sheet; and numeral 1203 a two-dimensional image display.

In the description below, the simply mentioned two-dimensional image display means a self-radiating luminescent image display, such as a liquid crystal display panel with a back light. The transmission two-dimensional image display which will be mentioned below means a device for displaying an image by two-dimensionally modulating a transmission factor of light, requiring an outside light source without self-radiation, such as a liquid crystal display panel without a backlight. The two-dimensional image projector which will be mentioned below means a device for focusing an image in mid air or on a screen outside the device without having a display plane within the device, such as a video projector.

As shown in FIGS. 2 and 3, as the multi-eye stereoscopic display system, a method using the lenticular sheets 1102 and 1202 is known in which the cylindrical lenses 1103, which are single-dimensional lenses, are aligned in one direction. The principle of this lenticular system will be described below.

As shown in FIG. 2, a plurality of the parallax images 1105 of an object viewed from various horizontal directions are respectively divided into longitudinal strips, which are nested and reconstituted so as to display them on the two-dimensional image display 1104. When a pair of strip images are arranged so as to correspond to one cylindrical lens, the respective parallax images 1105 are displayed in different horizontal directions, so that from the left and right eyes, different parallax images can be seen. Also, when the eyes are moved, parallax images in sight are switched.

As a method for displaying stereoscopic images as moving photo-realistic images, a method is known using the conventional two-dimensional image display 1104, such as a liquid crystal display panel.

As shown in FIG. 3, on the back surface of the lenticular sheet 1202, the diffuse reflection plate 1201 is attached, so that different images can also be displayed in different horizontal directions by projecting images from different horizontal directions with a plurality of the two-dimensional image display 1203. When a conventional video projector is used as the two-dimensional image display 1203, stereoscopic images can be displayed as moving photo-realistic images.

As described above, in a lenticular system, the lenticular sheets 1102 and 1202 are arranged in directions in which cylindrical lenses constituting the lenticular sheet are aligned.

As a system similar to the lenticular system, a parallax barrier system shown in FIG. 4 is known. In the drawing, reference numeral 1301 denotes a slit array called as a parallax barrier; numeral 1302 an individual slit; numeral 1303 a two-dimensional image display; and numeral 1304 a transmission two-dimensional image display.

FIG. 4(a) shows a schematic view of a horizontal section, and the individual slits 1302 constituting the parallax barrier 1301 have a function to change the traveling direction of light in the same way as in the individual cylindrical lenses constituting the lenticular sheet and used in the lenticular system.

FIG. 4(b) shows a schematic view of a horizontal section when the transmission two-dimensional image display 1304 is used, and the transmission two-dimensional image display 1304 is illuminated with light diffusing in horizontal directions after passing the parallax barrier 1301. Stereoscopic images can be displayed as moving photo-realistic images using a transmission liquid crystal display panel as the transmission two-dimensional image display.

### DISCLOSURE OF INVENTION

As described above, in the multi-eye stereoscopic display system, if the number of images displayed in different horizontal directions is large enough (about 50 to 100), the four human physiological factors of stereoscopic vision can be entirely satisfied so as to display natural stereoscopic images.

However, when the moving photo-realistic image display is assumed, in a method in that a lenticular screen is bonded on the two-dimensional image display, the number of images capable of being displayed is limited by the resolving score in the horizontal direction displayed on the two-dimensional image display. Therefore, the smooth movement parallax cannot be expressed so as to produce image skips, while there has been a problem of fatigue due to the contradiction between the focal point and the presented position on a three-dimensional object. In order to increase the number of images, it is required to have a two-dimensional image display with a very large resolving score in the horizontal directions in comparison with the vertical direction, and it has been difficult to be achieved. In a method in that images are projected on a reflection lenticular screen with a projector, a number of the projectors are required so that there has been a problem of a large scale device.

By solving the problems described above, it is an object of the present invention to provide a three-dimensional display method and a device therefor capable of displaying more plenty of images in horizontal directions as well as being capable of eliminating image skips by producing display angular-range overlaps between images having adjacent display directions.

According to the present invention, in order to achieve the object described above:

(1) A three-dimensional display method includes the steps of two-dimensionally arranging a plurality of image-generating sources in horizontal and vertical directions so as to differentiate between horizontal display directions; generating a vertical display angular range common to entire images by expanding display angular ranges only in the vertical direction with a vertical-direction diffusion plate so as to cancel differences in the vertical display direction and to enable a number of images different in horizontal display directions to be displayed; and generating a display angular range overlap between adjacent images so as to enable the images to be smoothly switched.

(2) A three-dimensional display method includes the steps of two-dimensionally arranging a plurality of imaging systems in horizontal and vertical directions so as to generate a plurality of images different in horizontal and vertical display directions; and generating images different in horizontal display directions by the number of the imaging systems by expanding display angular ranges only in the vertical direction with a vertical-direction diffusion plate.

(3) A three-dimensional display method includes the steps of generating a number of light rays proceeding in different vertical and horizontal directions by corresponding each individual lens to a two-dimensional light-source array as the individual lens of a two-dimensional lens array to be one pixel of stereoscopic display; and generating images different in horizontal display directions as the entire two-dimensional lens array by the number of the light sources of the two-dimensional light-source array by expanding display angular ranges only in the vertical direction with a vertical-direction diffusion plate.

(4) A stereoscopic display includes an array of two-dimensional image projectors two-dimensionally arranged in horizontal and vertical directions; an array of apertures arranged on the image-generating side of the two-dimensional image projector array; a common lens arranged on the image-generating side of the aperture array; a vertical-direction diffusion plate arranged on the image-generating side of the common lens; and an image plane generated in the vicinity of the vertical-direction diffusion plate, wherein a number of images different in horizontal display directions are generated.

(5) A stereoscopic display includes an array of two-dimensional image displays two-dimensionally arranged in horizontal and vertical directions; an array of lenses arranged on the image-generating side of the two-dimensional image display array; an array of apertures arranged on the image-generating side of the lens array; a common lens arranged on the image-generating side of the aperture array; and a vertical-direction diffusion plate arranged on the image-generating side of the common lens; and an image plane generated in the vicinity of the vertical-direction diffusion plate, wherein a number of images different in horizontal display directions are generated.

(6) A stereoscopic display includes an array of illumination optical systems two-dimensionally arranged in horizontal and vertical directions; an array of transmission two-dimensional image displays arranged on the image-generating side of the illumination optical system array; an array of lenses arranged on the image-generating side of the transmission two-dimensional image display array; a common lens arranged on the image-generating side of the lens array; a vertical-direction diffusion plate arranged on the image-generating side of the common lens; and an image plane generated in the vicinity of the vertical-direction diffusion plate on the image-generating side, wherein a number of images different in horizontal display directions are generated.

(7) A stereoscopic display includes an array of illumination optical systems two-dimensionally arranged in horizontal and vertical directions; an array of transmission two-dimensional image displays arranged on the image-generating side of the illumination optical system array; an array of lenses arranged on the image-generating side of the transmission two-dimensional image display array; an array of apertures arranged on the image-generating side of the lens array; a common lens arranged on the image-generating side of the aperture array; a vertical-direction diffusion plate arranged on the image-generating side of the common lens; and an image plane generated in the vicinity of the vertical-direction diffusion plate on the image-generating side, wherein a number of images different in horizontal display directions are generated.

(8) A stereoscopic display includes an array of light sources two-dimensionally arranged in horizontal and vertical directions; a micro-lens arranged on the image-generating side of the light source array; and a display plane made of a two-dimensional array of pixels and having a vertical-direction diffusion plate arranged on the image-generating side of the micro-lens, wherein a number of images different in horizontal display directions are generated.

(9) A stereoscopic display includes an array of light sources two-dimensionally arranged in horizontal and vertical directions; a pinhole arranged on the image-generating side of the light source array; and a display plane made of a two-dimensional array of pixels and having a vertical-direction diffusion plate arranged on the image-generating side of the pinhole, wherein a number of images different in horizontal display directions are generated.

(10) A stereoscopic display includes a divergent light source; an array of transmission light modulators arranged on the image-generating side of the divergent light source; and a display plane made of a two-dimensional array of pixels and having a vertical-direction diffusion plate arranged on the image-generating side of the transmission light modulator array, wherein a number of images different in horizontal display directions are generated.

### BRIEF DESCRIPTION OF THE DRAWINGS

FIG. 1 is an explanatory drawing of a conventional binocular stereoscopic display system.

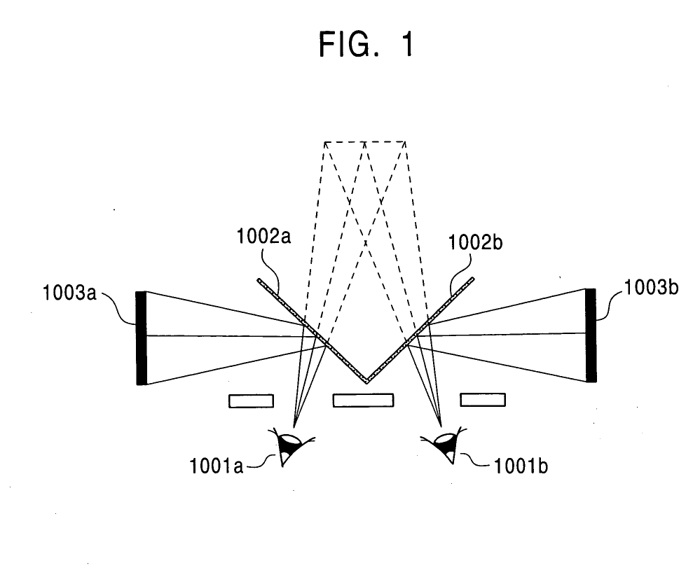

FIG. 2 is a block diagram of a conventional device realizing a multi-eye stereoscopic display system using a lenticular sheet.

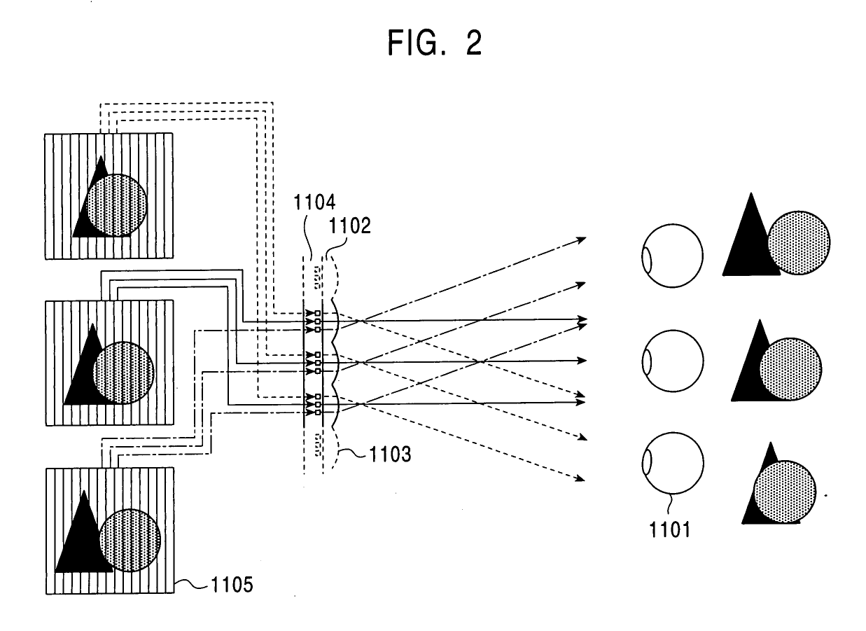

FIG. 3 is a block diagram of a conventional device realizing a multi-eye stereoscopic display system using a reflection lenticular sheet.

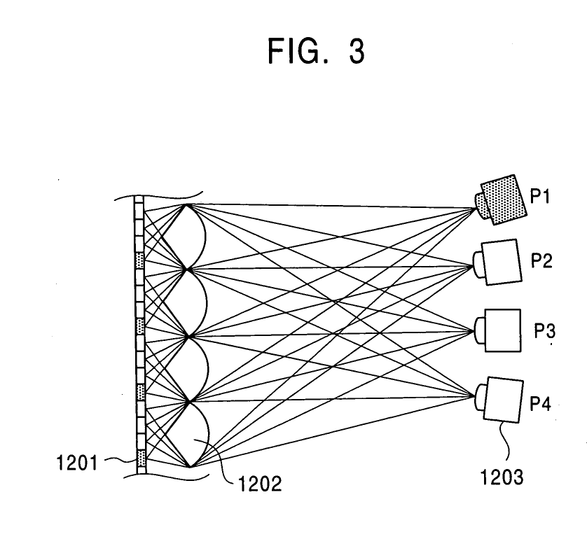

FIG. 4 is a block diagram of a conventional device realizing a multi-eye stereoscopic display system using a parallax barrier.

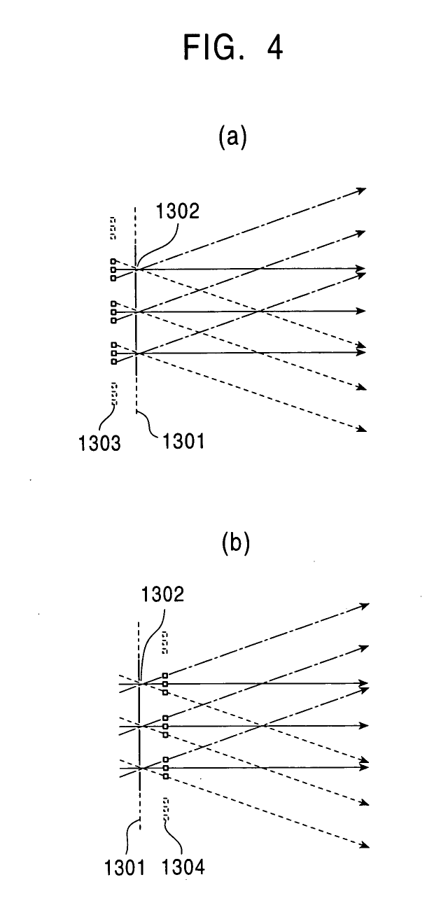

FIG. 5 is an explanatory drawing of high-density horizontal parallax image display produced by amalgamation between two-dimensional arrangement of display angular ranges of image generating sources and vertical display angular ranges, showing a principle of the present invention.

FIG. 6 is a block diagram (No. 1) of a stereoscopic display showing a first embodiment of the present invention.

FIG. 7 is a block diagram (No. 2) of the stereoscopic display showing the first embodiment of the present invention.

FIG. 8 is an explanatory drawing of display directions in a multiple imaging system according to the first embodiment of the present invention.

FIG. 9 is an explanatory drawing of a display angular range according to the first embodiment of the present invention.

FIG. 10 is a block diagram of a modification of the stereoscopic display in the vicinity of a two-dimensional image display, showing the first embodiment of the present invention.

FIG. 11 is an explanatory drawing of the function of the lenticular sheet.

FIG. 12 is a block diagram of a stereoscopic display showing a second embodiment of the present invention.

FIG. 13 is an explanatory drawing of display directions with a micro-lens according to the second embodiment of the present invention.

FIG. 14 is an explanatory drawing of display angular ranges according to the second embodiment of the present invention.

FIG. 15 is a block diagram of a modification of the stereoscopic display in the vicinity of a light-source array, showing the second embodiment of the present invention.

### BEST MODE FOR CARRYING OUT THE INVENTION

Embodiments of the present invention will be described below in detail.

At first, terms, which will be used in the description below, are described. An emitting angle of light emitted from a display plane of an image is called as a display angle; when the emitting angle of light is limited within an angular range, this angular range is called as a display angular range; wherein the emitting angle is to be measured from the normal line of an image plane. That is, when the image plane is viewed, an image can be viewed only within the display angular range. The central axial direction of the display angular range is called as a display direction. Also, a two-dimensional image display and a light source array used for image display are collectively called as an image generating source.

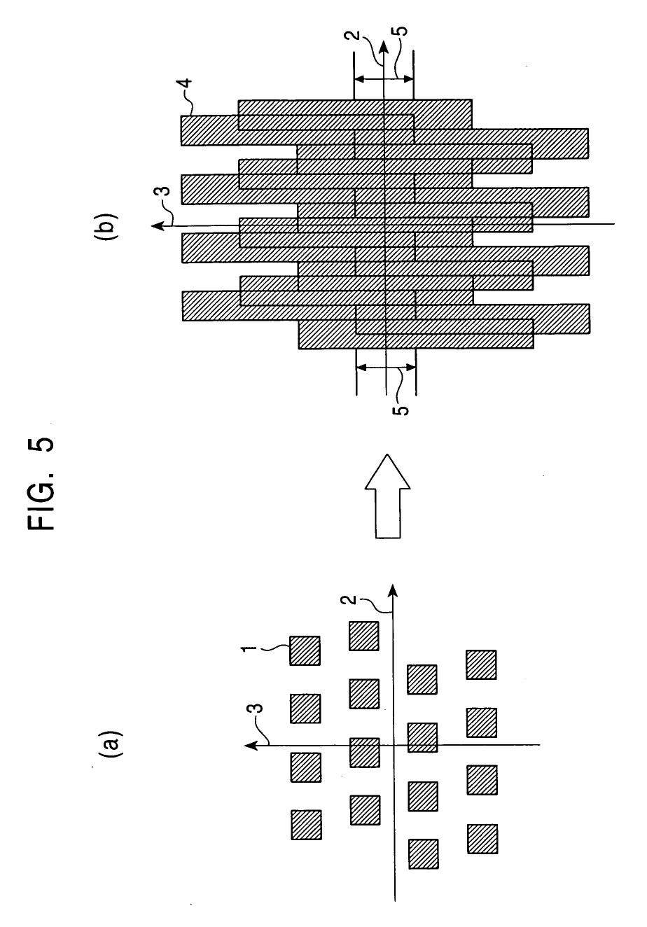

FIG. 5 is an explanatory drawing of high-density horizontal parallax image display produced by amalgamation between two-dimensional arrangement of display angular ranges of a plurality of image generating sources and vertical display angular ranges, showing a principle of the present invention; FIG. 5(a) shows the two-dimensional arrangement of the display angular ranges of the image generating sources; and FIG. 5(b) shows that a common vertical display angular range is generated by expanding the vertical display angular ranges.

In these drawings, reference numeral 1 denotes a display angular range of an image; numeral 2 a horizontal display angle; numeral 3 a vertical display angle; numeral 4 a display angular range of each image expanded in the horizontal direction; and numeral 5 a common vertical display angular range.

In the past, in order to display images different in horizontal display directions, image-generating sources were aligned only in the horizontal directions. According to the present invention, by arranging the image-generating sources in the vertical directions in addition to the horizontal directions, a number of the image-generating sources can be arranged. When the image-generating sources are two-dimensionally arranged, which will be described later in description of the embodiment, the display angular ranges of images are also distributed two-dimensionally. Wherein, the entire images are arranged so as to be different in horizontal display directions.

For example, the image-generating sources are two-dimensionally arranged so that the display angular range of each image is to be as shown in FIG. 5(a). In order to arrange the image-generating sources also in the vertical directions, the discrepancy between the vertical display directions of images becomes a problem; however, using a vertical-direction diffusion plate (not shown) that diffuses light only in the vertical direction, the vertical display angular range of each image is expanded so as to generate a vertical display angular range common to the entire images (common vertical display angular range) 5 as shown in FIG. 5(b). In this range, the entire images are displayed in different horizontal directions so that the same effect can be obtained as that when the entire image-generating sources are arranged in the horizontal direction. That is, in this vertical display angular range, when a viewing point is moved in the horizontal direction, the entire images can be observed, and further, each image has a different horizontal display direction.

Specific examples will be described below in detail.

First, multiplex-display in units of image plane will be described.

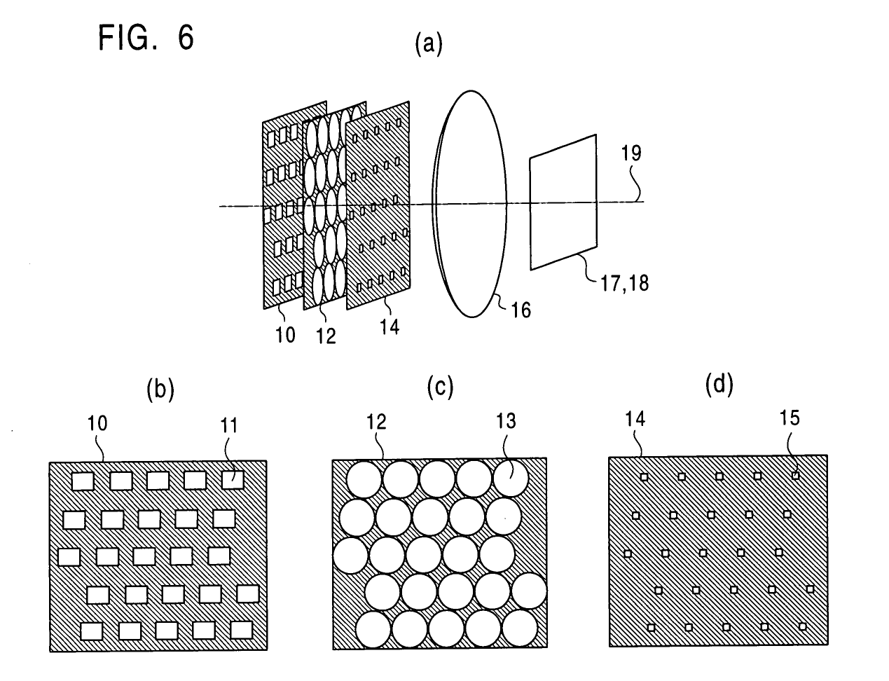

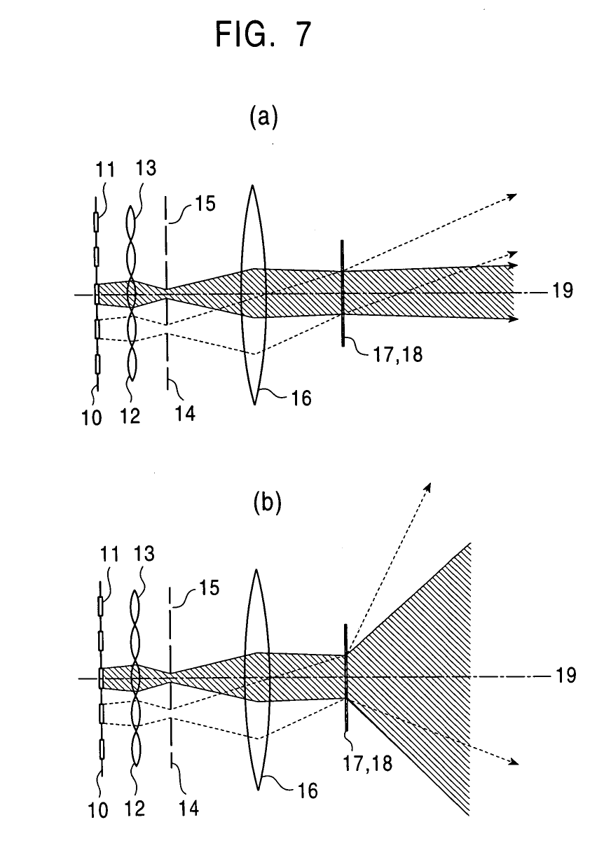

FIG. 6 is a block diagram (No. 1) of a stereoscopic display showing a first embodiment of the present invention; FIG. 6(a) is an overall schematic view; FIG. 6(b) is a plan view of its two-dimensional image display array; FIG. 6(c) is a plan view of its lens array; and FIG. 6(d) is a plan view of its aperture array. Also, FIG. 7 is a block diagram (No. 2) of the stereoscopic display showing the first embodiment of the present invention; FIG. 7(a) is a schematic view showing its horizontal section; and FIG. 7(b) is a schematic view showing its vertical section.

In these drawings, reference numeral 10 denotes a two-dimensional image display array; numeral 11 each individual two-dimensional image display; numeral 12 a lens array; numeral 13 each lens; numeral 14 an aperture array; numeral 15 each aperture; numeral 16 a common lens; numeral 17 a vertical diffusion plate; numeral 18 a common image plane; and numeral 19 an optical axis.

According to the embodiment, the image display is multiplexed in units of image plane. That is, imaging systems are two-dimensionally arranged so as to generate a plurality of images different in display horizontal and vertical directions and to cancel differences in vertical display directions with the vertical diffusion plate 17. By arranging imaging systems so that entire images have different horizontal display directions, images different in horizontal display directions can be generated by the number of the imaging systems.

In detail, as shown in FIG. 7(a) and FIG. 7(b), a plurality of afocal optical systems are multiplexed. In general, an afocal optical system is composed of two lenses; however, according to the embodiment, optical systems are multiplexed using one common lens 16 as a common lens on the image side. The two-dimensional image displays 11 are arranged on object surfaces of the respective afocal optical systems so as to display images respectively different in viewing points. Images of the entire afocal optical systems are focused at the same position on the common image plane 18. The images on the common image plane 18 are displayed in horizontal and vertical directions differently corresponding to positions of the afocal imaging systems relative to the optical axis 19.

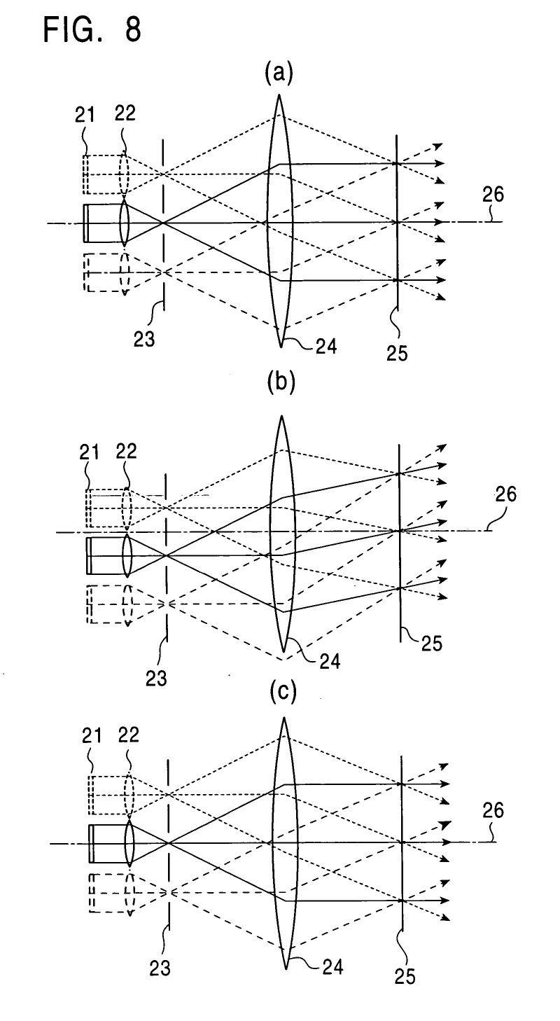

This is described with reference to FIG. 8. In the drawing, reference numeral 21 denotes a two-dimensional image display; numeral 22 a lens; numeral 23 an aperture array; numeral 24 a common lens; numeral 25 a common image plane; and numeral 26 an optical axis. FIG. 8(a) is a horizontally sectional schematic view of multiple-imaging systems showing that the position of the combination of the two-dimensional image display 21 with the lens 22 relative to the optical axis 26 determines the horizontal display direction of the image on the common image plane 25.

FIG. 8(b) is a horizontally sectional view in a vertical position different from FIG. 8(a) showing that since the position of the combination of the two-dimensional image display 21 with the lens 22 relative to the optical axis 26 is different from that in FIG. 8(a), images are displayed in the horizontal directions different from those of FIG. 8(a).

FIG. 8(c) is a Vertically sectional schematic view of the multiple-imaging systems showing that the vertical display direction is determined corresponding to the position of the combination of the two-dimensional image display 21 with the lens 22 relative to the optical axis 26.

Wherein, the two-dimensional image generating device 11, the lens 13, and the aperture 15 constituting the afocal optical system are two-dimensionally arranged so that entire images have different horizontal display directions. For example, as shown in FIG. 6(b) to FIG. 6(d), these are two-dimensionally arranged. Furthermore, in the vicinity of the common image plane 18 of the multiple-imaging system, the vertical diffusion plate 17 expanding light only in the vertical direction is arranged.

By doing so, although the horizontal display angular range is not changed as shown in FIG. 7(a), since the vertical display angular ranges of entire images are expanded as shown in FIG. 7(b), a display angular range common to the entire images is generated in the vertical direction. This corresponds to the common vertical display angular range 5 shown in FIG. 5(b), and in this angular range, when the viewing point is moved in the horizontal direction, the entire images can be observed. Furthermore, each image has a different display direction in the horizontal direction.

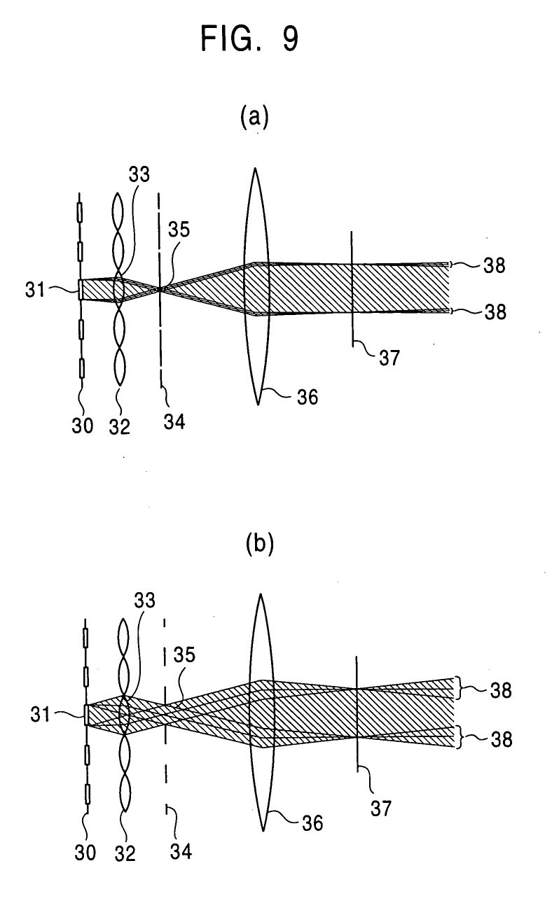

As shown in FIG. 9, an aperture array 34 arranged between a lens array 32 and a common lens 36 has a function to determine the display angular range of each image generated by the multiple imaging system. As shown in FIG. 9(a), in the case where each aperture 35 of the aperture array 34 is small, a display angular range 38 of an image generated by each individual afocal optical system is small.

As shown in FIG. 9(b), when the aperture 35 is expanded, the display angular range 38 becomes larger. In such a manner, since the size of the aperture 35 determines the display angular range 38 of an image, the distribution of the apertures in the aperture array 34 approximately agrees with the distribution of the display angular ranges shown in FIG. 5(a). In addition, reference numeral 31 denotes a two-dimensional image display; numeral 33 each lens; and numeral 37 a common image plane.

That is, FIG. 6(d) agrees with FIG. 5(a). Therefore, when the aperture is small, between display angular ranges of adjacent images having a horizontal display direction, a skip is generated, so that when eyes are moved in the horizontal direction, a range where an image cannot be viewed is produced. This is called as an image skip. When the afocal optical systems are arranged only in the horizontal direction, no matter how large the aperture is expanded, it is a limit to bring a display angular range of an image into contact with that of the adjacent image, and an overlap cannot be generated therebetween.

Whereas, when the afocal optical systems are two-dimensionally arranged, as shown in FIG. 5(b), an overlap can be generated between display angular ranges of adjacent images having horizontal display directions, so that the image skip can be eliminated, achieving smooth movement parallax.

Instead of arranging the aperture array 34 between the lens array 32 and the common lens 36, controlling an emitting angle of light emitted from the two-dimensional image display 31 takes the same effect as that of the case where the aperture array 34 is provided.

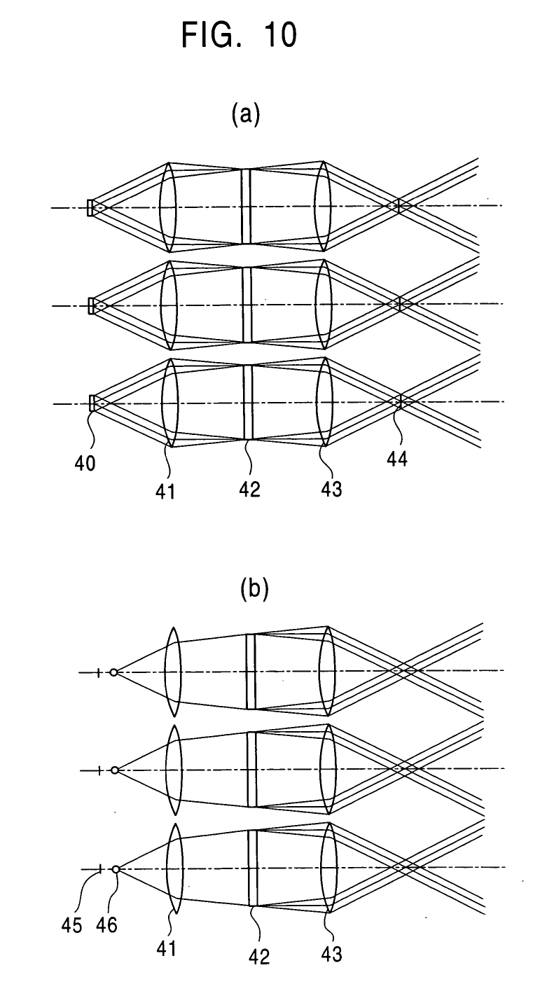

FIG. 10(a) shows a constitutive method using a surface light source 40, an illumination lens 41, a transmission two-dimensional image display 42. In an imaging system including the illumination lens 41 and a lens 43, by focusing an image 44 of the surface light source 40 at the same position and in the same size as those of the aperture 35 (see FIG. 9) of the aperture array 34 (see FIG. 9), an emitting angle of light emitted from the transmission two-dimensional image display 42 can be controlled. The surface light source 40 is also replaceable with the aperture in their combination.

FIG. 10(b) shows a constitutive method using a point light source 42, the illumination lens 41, and the transmission two-dimensional image display 42. By arranging the point light source 46 at a position adjacent to the illumination lens 41 closer than a focal point position 45 of the illumination lens 41 so as to illuminate the transmission two-dimensional image display 42 with divergent light, an emitting angle of light emitted from the transmission two-dimensional image display 42 can be controlled. The point light source 46 is also replaceable with the pinhole in their combination. The two constitutive methods described above may be combined.

Furthermore, these constitutive methods may be obviously combined with the aperture array. In addition to these, any one can be used as long as it can limit an emitting angle of light emitted from the two-dimensional image display.

As a common lens of the multiple imaging system, a lens at least larger than the lens array is required. A Fresnel lens can be used therefor. The Fresnel lens is thin and light-weight in comparison with a spherical lens. Other than these lenses, a spherical mirror can be used, and in this case, an optical path of an optical system is folded with the spherical mirror so as to miniaturize the entire device.

As a two-dimensional image display, a conventional two-dimensional image display such as a liquid crystal display panel may be used. When a small-sized liquid crystal display panel is used, a number of images can be two-dimensionally arranged, enabling moving photo-realistic images to be displayed. Other than these, any two-dimensional image display may be used as long as it can generate two-dimensional images.

A small-sized liquid crystal display panel may have a size of about 20 mm×20 mm, for example. In this case, when they are arranged two-dimensionally according to the embodiment, even about 50 to 100 of panels are arranged, these panels may occupy only an area of about 140 mm×140 mm to 200 mm×200 mm. Whereas, when they are arranged only in the horizontal direction in such a conventional manner, a width of about 1000 mm to 2000 mm is necessary to be placed.

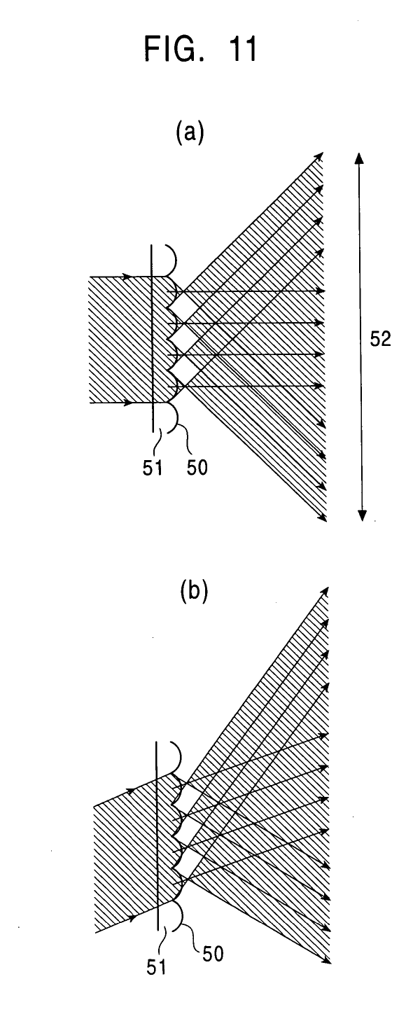

As a vertical diffusion plate, a lenticular sheet may be used. As shown in FIG. 11(a), when light enters a lenticular sheet 51 having cylindrical lenses 50, which are single-dimensional lenses, arranged thereon, the light is diffused only in an alignment direction 52 of the cylindrical lenses while not diffused in a direction perpendicular thereto.

As shown in FIG. 11(b), the lenticular sheet 51 single-dimensionally diffuses inclined incident light about its inclination as the center. Therefore, as shown in FIG. 5, the display angular range expands only in the vertical direction while maintaining the center of the display angular range of incident images. In addition to the lenticular sheet, a holographic optical element may be used as a vertical diffusion plate. Other than these, any one may be used as a vertical diffusion plate as long as it diffuses light only in the vertical direction (one direction).

The present invention is featured by the point that the lenticular sheets are arranged so that the cylindrical lenses are aligned in the vertical direction differently from a conventional lenticular system.

Since the multiple imaging system is a non-coaxial optical system, image distortion due to aberration may be produced. By optimally designing an optical system such as a lens, the image distortion can be suppressed by reducing the aberration. Additionally, two-dimensional images to be displayed on the two-dimensional image display can also be corrected by conversely distorting them with an electrical technique.

In an afocal optical system composed of two lenses, the lenses are generally arranged so that focal planes of the lenses agree with each other, and an object and an image plane of one lens are arranged on the focal plane of the other lens.

When this is described with reference to FIG. 6 and FIG. 7, the focal planes of the lens 13 and the common lens 16, which constitute the lens array 12, agree with each other. On the other focal surface of the lens 13, the two-dimensional image display array 11 is arranged while on the other focal surface of the common lens 16, the common image plane 18 is arranged. According to the embodiment, various imaging systems achieving the imaging relationship between the two-dimensional image display and the image plane may be additionally used.

As two-dimensional arrangement of afocal optical systems constituting the multiple imaging system, in addition to the two-dimensional arrangement shown in FIG. 6(b) to FIG. 6(d), various arrangements are enabled, in which horizontal positions of individual imaging systems do not agree with each other. The two-dimensional arrangement shown in FIG. 6(b) to FIG. 6(d) is arrangement designed in view that when the distance between the optical axis 19 of the multiple imaging system and each individual afocal optical system is increased, image distortion due to aberration increases. Although, in FIG. 6(b) to FIG. 6(d), the afocal optical systems are arranged in equal intervals for brevity, they are not necessarily arranged in equal intervals. In particular, for maintaining angular changes of adjacent images having the horizontal display direction constant in the horizontal direction, it is preferable that the interval in the horizontal direction be rather increased with decreasing distance to the periphery from the center.

Next, a second embodiment according to the present invention will be described.

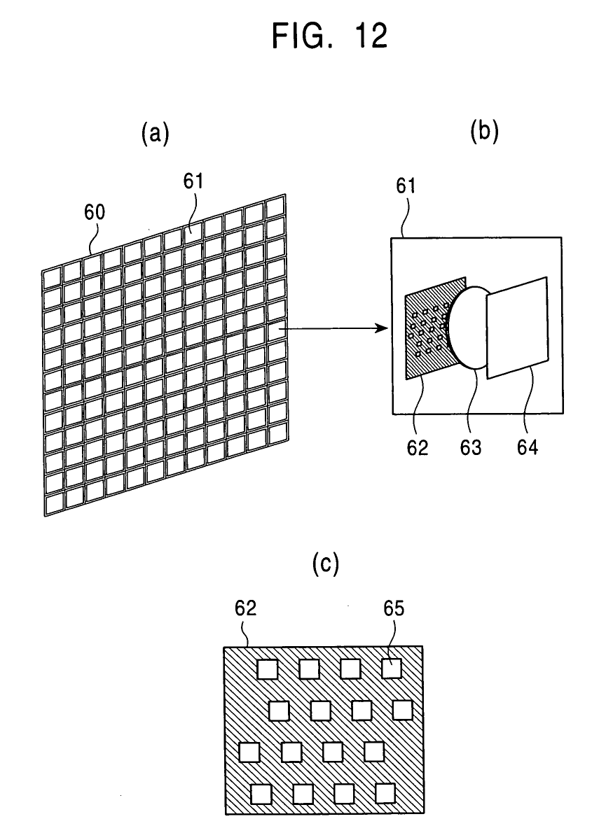

FIG. 12 is a block diagram showing the second embodiment according to the present invention; FIG. 12(a) is a schematic view of a display plane; FIG. 12(b) a schematic view showing the structure of one pixel on the display plane; and FIG. 12(c) a plan view of the light source array. In these drawings, reference numeral 60 denotes a display plane; numeral 61 one pixel of the light source array; numeral 62 the light source array; numeral 63 a micro-lens; numeral 64 a vertical diffusion plate; and numeral 65 a light source.

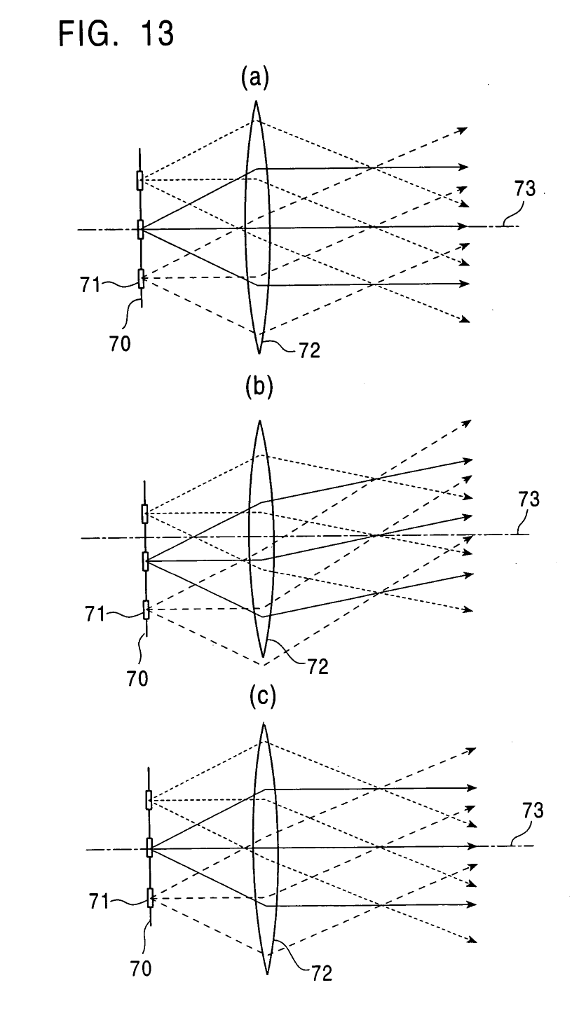

In this embodiment, the multiple image display in units of image plane will be described.

Wherein, using a micro-lens array, each micro-lens 63 is used as one pixel of the stereoscopic image display. On the focal plane of the micro-lens 63, a two-dimensionally arranged light-source array 62 is provided. A light ray emitted from each light source 65 constituting the light-source array 62 has proceeding vertical and horizontal directions corresponding to the position of the light source 65 relative to the micro-lens 63 after passing thorough the micro-lens 63. This will be described with reference to FIG. 13.

FIG. 13(a) is a schematic view illustrating a horizontal sectional view of one pixel, showing that the position of a light source 71 relative to an optical axis 73 of a micro-lens 72 determines a horizontal proceeding direction of light after passing through the lens. FIG. 13(b) is a horizontal sectional view at a vertical position different from FIG. 13(a), showing that since the position of the light source 71 relative to the optical axis 73 is different from that in FIG. 13(a), the horizontal proceeding direction of the light is different from that in FIG. 13(a). FIG. 13(c) is a vertical sectional view showing that the position of the light source 71 relative to the optical axis 73 determines a vertical proceeding direction of the light.

Wherein, the two-dimensional arrangement of the light sources 71 of a light-source array 70 is determined so that light rays from the entire light sources have different horizontal directions. For example, the light sources are arranged as shown in FIG. 12(c). Then, when the light proceeding direction is expanded with a vertical diffusion plate 64 only in the vertical direction, a vertical proceeding direction range common to light rays from the entire light sources is generated.

In this vertical proceeding direction range, light rays from light sources have horizontal proceeding directions different from each other. That is, the light ray emitted from the micro-lens can be controlled by corresponding to its horizontal proceeding direction. When each individual micro-lens is used as one pixel of the stereoscopic display so as to display the entire screen with the entire micro-lens arrays, images can be displayed differently corresponding to the light horizontal proceeding direction. That is, among the entire display planes 60, a light source group located at the same relative position within the light-source array 62 produces images in one horizontal display direction. Also, images can be displayed by the number of light sources constituting the light-source array 62.

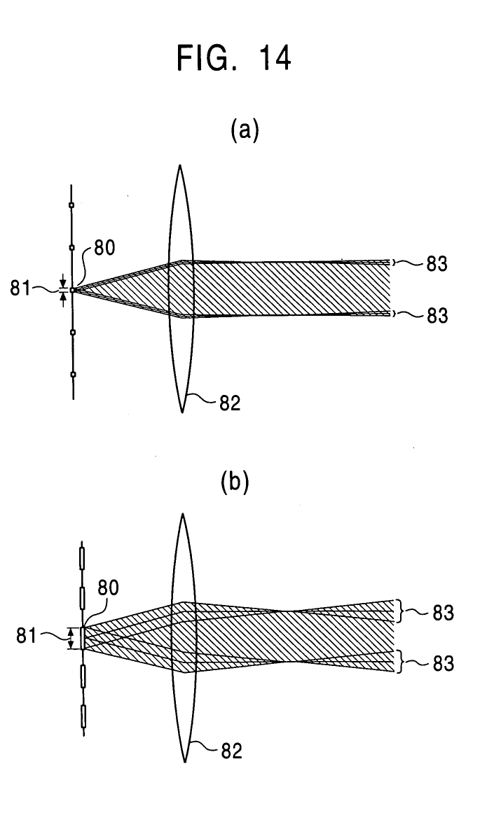

The horizontal width of the light source 65 constituting the light-source array 62 determines the display angular range of the corresponding image. This will be described with reference to FIG. 14.

As shown in FIG. 14(a), when a horizontal width 81 of a light source 80 is small, a display angular range 83 of each image is small. As shown in FIG. 14(b), when the horizontal width 81 of the light source 80 is increased, the display angular range 83 of each image is increased. In the drawing, reference numeral 82 denotes a micro-lens.

In such a manner, the size of the light source 80 determines the display angular range 83 of each image, so that the distribution of light sources in the light-source array 62 appropriately determines the distribution of display angular ranges shown in FIG. 5(a). That is, FIG. 12(c) agrees with FIG. 5(a). Therefore, when each horizontal width 81 is small, between display angular ranges of adjacent images having horizontal directions, an image skip is generated, so that when a sight line is moved in the horizontal direction, a range where an image is out of sight is generated.

As in the lenticular system, when light sources of a light-source array are arranged only in the horizontal directions, it is a limit to bring a display angular range of an image into contact with that of the adjacent image, and an overlap cannot be generated therebetween. Whereas, according to the embodiment, when the light source arrays are two-dimensionally arranged, as shown in FIG. 5(b), an overlap can be generated between display angular ranges of adjacent images having horizontal display directions, so that the image skip can be eliminated, achieving smooth movement parallax.

In the description with reference to FIG. 12, the light-source array 62 is located on the focal plane of the micro-lens 63. However, since the function of the micro-lens 63 is to change the light proceeding direction, even if the light-source array 62 is located at a position other than the focal plane, the light proceeding direction is changed, so that the position where the light-source array 62 is arranged is not limited to the focal plane of the micro-lens 63.

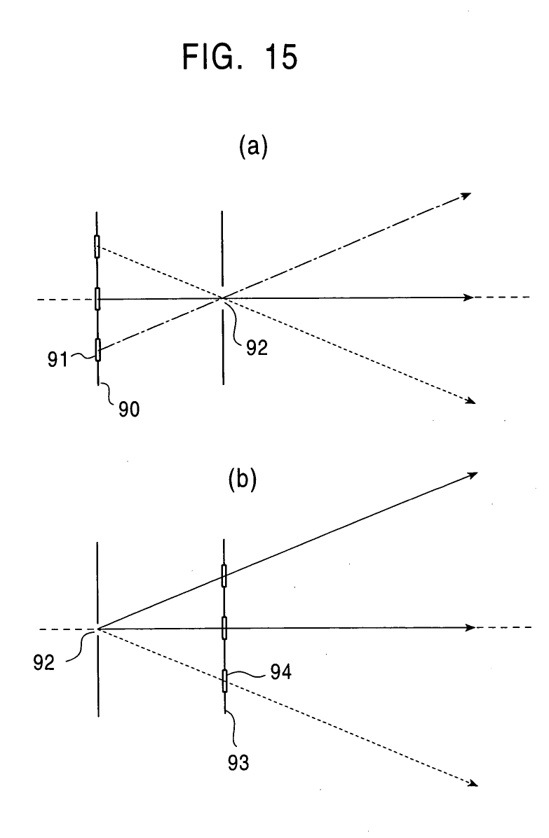

Also, in addition to the micro-lens, as shown in FIG. 15, the light proceeding direction can be changed using a pinhole 92. As shown in FIG. 15(a), by forming a pinhole 92 at a position on an emitting side of light from a light-source array 90, the light proceeding direction of the emitted light after passing through the pinhole 92 is determined corresponding to the relative position of a light source 91 in the light-source array 90.

Furthermore, as shown in FIG. 15(b), using a light modulator array 93 instead of the light-source array 90, providing the pinhole 92 at a position on the incident side of the light modulator array 93 also achieves the same function. Wherein, the light modulator is an element capable of controlling the transmittancy of light. The proceeding direction of light emitted from each light modulator 94 is determined by the relative position of the light modulator 94 in the light modulator array 93. In this case, a point light source may also be used instead of the pinhole. In addition to the micro-lens and the pinhole, any one may be used as long as it can change the light proceeding direction.

As the two-dimensional arrangement of light sources in the light-source array, other than the arrangement shown in FIG. 12(c), various arrangements can be made if the horizontal position of each light source agrees with each other. In FIG. 12(c), the light sources are shown for brevity to be the arrangement in equal intervals in the horizontal and vertical directions; however, it is not necessarily in equal intervals. In particular, for maintaining angular changes of adjacent images having the horizontal display direction constant in the horizontal direction, it is preferable that the interval in the horizontal direction be rather increased with decreasing distance to the periphery from the center. For colorizing stereoscopic images according to the embodiment, the same technique as in a conventional two-dimensional image display may be used. For example, methods may be used, such as a method using light sources of the three RGB primary colors as one light source together and a method of combining three light-source groups individually prepared corresponding to the three RGB primary colors with a half mirror.

According to the embodiment, a light-source array group may be substituted for the three-dimensional image display. In this case, the display can be easily processed into moving photo-realistic images. One pixel of the three-dimensional image display is corresponded to one light source. However, the three-dimensional image display is required to have a unique pixel arrangement as shown in FIG. 12(c), for example. In a general three-dimensional image display, an orthogonal pixel arrangement is used, and this pixel arrangement may be inclined for use or may be optically converted with an optical element. According to the embodiment, it is not necessary to arrange pixels in high density only in the horizontal direction as in a conventional lenticular system, and the pixels may be two-dimensionally arranged in equal densities. As a three-dimensional image display, a highly fine liquid crystal display panel may be used.

Instead of two-dimensionally arranging the light-source array group in practice, spatially scanning light sources with a scanning optical system may have the same effect as that in the two-dimensional arrangement of light sources. As a scanning method, there are methods such as a method in which one or a plurality of light sources are two-dimensionally scanned in the horizontal and vertical directions, a method in which single-dimensional light-source arrays arranged in the vertical direction or two-dimensional light-source arrays are single-dimensionally scanned in the horizontal direction, and a method in which single-dimensional light-source arrays arranged in the horizontal direction or two-dimensional light-source arrays are single-dimensionally scanned in the vertical direction.

As a vertical diffusion plate (one-direction diffusion plate), a lenticular sheet and a holographic optical element may be used. Other than these, any one may be used as long as it diffuses light in one direction.

The lens array and the vertical diffusion plate may be replaced with an integrated element having a combined function of those of the both elements.

Although the present embodiment is identical to a conventional lenticular system or IP system in that both use a light-source array, it is apparently different therefrom in that light sources constituting a light-source array are two-dimensionally arranged so that the horizontal positions do not agree with each other and in that the vertical display angular ranges are expanded using a single-dimensional diffusion plate so as to merge with each other.

In addition, the present invention is not limited to the embodiments described above, and various modifications can be made based on the spirit of the present invention, which must not be barred out of the scope of the invention.

As described above in detail, there has been a problem of a conventional multi-eye stereoscopic display in that a sufficient number of images cannot be displayed in the horizontal directions. Whereas, according to the present invention, the number of images to be displayed in the horizontal directions can be increased to a large degree. Therefore, the smooth movement parallax is achieved while the problem of inconsistency between the adjustment and convergence is solved.

Also, the display angular ranges of adjacent images having horizontal display directions can be overlapped with each other, eliminating an image skip produced when a viewing point is moved.

Furthermore, the display can be easily processed into moving photo-realistic images.

### INDUSTRIAL APPLICABILITY

The present invention is preferably incorporated in a stereoscopic display capable of increasing the number of images displayed in the horizontal directions to a large extent.

1. A three-dimensional display method comprising the steps of:
two-dimensionally arranging a plurality of image-generating sources in horizontal and vertical directions so as to differentiate between horizontal display directions;
generating a vertical display angular range common to entire images by expanding the display angular ranges only in the vertical direction with a vertical-direction diffusion plate so as to cancel differences in the vertical display directions and to enable a number of images different in horizontal display directions to be displayed; and
generating a display angular range overlap between adjacent images so as to enable the images to be smoothly switched.

2. A three-dimensional display method comprising the steps of:
two-dimensionally arranging a plurality of imaging systems in horizontal and vertical directions so as to generate a plurality of images different in horizontal and vertical display directions; and
generating images different in horizontal display directions by the number of the imaging systems by expanding display angular ranges only in the vertical direction with a vertical-direction diffusion plate.

3. A three-dimensional display method comprising the steps of:
generating a number of light rays proceeding in different vertical and horizontal directions by corresponding each individual lens to a two-dimensional light-source array using each individual lens of a two-dimensional lens array as one pixel of stereoscopic display; and
generating images different in horizontal display directions as the entire two-dimensional lens array by the number of the light sources of the two-dimensional light-source array by expanding display angular ranges only in the vertical direction with a vertical-direction diffusion plate.

4. A stereoscopic display comprising:
(a) an array of two-dimensional image projectors two-dimensionally arranged in horizontal and vertical directions;
(b) an array of apertures arranged on the image-generating side of the two-dimensional image projector array;
(c) a common lens arranged on the image-generating side of the aperture array;
(d) a vertical-direction diffusion plate arranged on the image-generating side of the common lens; and
(e) an image plane generated in the vicinity of the vertical-direction diffusion plate,
(f) wherein a number of images different in horizontal display directions are generated.

5. A stereoscopic display comprising:
(a) an array of two-dimensional image displays two-dimensionally arranged in horizontal and vertical directions;
(b) an array of lenses arranged on the image-generating side of the two-dimensional image display array;
(c) an array of apertures arranged on the image-generating side of the lens array;
(d) a common lens arranged on the image-generating side of the aperture array; and
(e) a vertical-direction diffusion plate arranged on the image-generating side of the common lens; and
(f) an image plane generated in the vicinity of the vertical-direction diffusion plate,
(g) wherein a number of images different in horizontal display directions are generated.

6. A stereoscopic display comprising:
(a) an array of illumination optical systems two-dimensionally arranged in horizontal and vertical directions;
(b) an array of transmission two-dimensional image displays arranged on the image-generating side of the illumination optical system array;
(c) an array of lenses arranged on the image-generating side of the transmission two-dimensional image display array;
(d) a common lens arranged on the image-generating side of the lens array;
(e) a vertical-direction diffusion plate arranged on the image-generating side of the common lens; and
(f) an image plane generated in the vicinity of the vertical-direction diffusion plate on the image-generating side,
(g) wherein a number of images different in horizontal display directions are generated.

7. A stereoscopic display comprising:
(a) an array of illumination optical systems two-dimensionally arranged in horizontal and vertical directions;
(b) an array of transmission two-dimensional image displays arranged on the image-generating side of the illumination optical system array;
(c) an array of lenses arranged on the image-generating side of the transmission two-dimensional image display array;
(d) an array of apertures arranged on the image-generating side of the lens array;
(e) a common lens arranged on the image-generating side of the aperture array;
(f) a vertical-direction diffusion plate arranged on the image-generating side of the common lens; and
(g) an image plane generated in the vicinity of the vertical-direction diffusion plate on the image-generating side,
(h) wherein a number of images different in horizontal display directions are generated.

8. A stereoscopic display comprising:
(a) an array of light sources two-dimensionally arranged in horizontal and vertical directions;
(b) a micro-lens arranged on the image-generating side of the light source array; and
(c) a display plane made of a two-dimensional array of pixels and having a vertical-direction diffusion plate arranged on the image-generating side of the micro-lens,
(d) wherein a number of images different in horizontal display directions are generated.

9. A stereoscopic display comprising:
(a) an array of light sources two-dimensionally arranged in horizontal and vertical directions;
(b) a pinhole arranged on the image-generating side of the light source array; and
(c) a display plane made of a two-dimensional array of pixels and having a vertical-direction diffusion plate arranged on the image-generating side of the pinhole,
(d) wherein a number of images different in horizontal display directions are generated.

10. A stereoscopic display comprising:
(a) a divergent light source;
(b) an array of transmission light modulators arranged on the image-generating side of the divergent light source; and
(c) a display plane made of a two-dimensional array of pixels and having a vertical-direction diffusion plate arranged on the image-generating side of the transmission light modulator array,
(d) wherein a number of images different in horizontal display directions are generated.
